(19) United States
(12) Patent Application Publication
(10) Pub. No.: US 2025/0018770 A1
(43) Pub. Date: Jan. 16, 2025

(54) HEATING APPARATUS FOR VEHICLE

(71) Applicants: YURA TECH CO., LTD., Sejong (KR); ESTRA AUTOMOTIVE SYSTEMS CO., LTD., Daegu (KR)

(72) Inventors: Yong Jun PARK, Cheonan-si, Chungcheongnam-do (KR); Keun Hyeong KIM, Sejong (KR); Byung Wook KWON, Seoul (KR); Sung Won KANG, Changwon-si, Gyeongsangnam-do (KR)

(73) Assignees: YURA TECH CO., LTD., Sejong (KR); ESTRA AUTOMOTIVE SYSTEMS CO., LTD., Daegu (KR)

(21) Appl. No.: 18/714,416

(22) PCT Filed: Nov. 1, 2022
(86) PCT No.: PCT/KR2022/016915

§ 371 Date: May 29, 2024

(30) Foreign Application Priority Data
Nov. 30, 2021 (KR) 10-2021-0168642

(51) Int. Cl. B60H 1/22

(52) U.S. Cl. CPC B60H 1/2221

(57) ABSTRACT

A heating apparatus for a vehicle of an embodiment of the present invention comprises: a body having an accommodation space with one open side surface formed therein; a heat-generating portion which is installed in the open surface of the accommodation space, and provides heat; and an inlet/outlet portion which is connected to the body so that a heat transfer medium can be input/output into/from the accommodation space, wherein, as the heat-generating portion is installed, a flow path that is in communication with the inlet/outlet portion is formed between the body and the heat-generating portion, and thus, the productivity of the items is noticeably improved.

### TECHNICAL FIELD

The present invention relates to a heating apparatus for a vehicle, and more particularly, to a heating apparatus for a vehicle, which supplies heat to a circulating heat transfer media to heat the heat transfer media.

### BACKGROUND ART

An electric heating apparatus generates heat used as a heat source of a vehicle, transfers the generated heat to a heat transfer medium, and ultimately heats air through the heated heat transfer medium to transfer the heat to the destination such as a vehicle's cabin, etc.

Here, in order to stably and uniformly transfer the heat to the heat transfer medium, an additional structure that provides a flow path is installed inside the heating apparatus so that the heat transfer medium is circulated inside the heating apparatus to uniformly transfer the heat.

As a result, there is a problem that fatigue of a worker increases to install the addition structure, and a size of the heating apparatus increases, and also, the number of required members increases to increase in cost of the product.

### DISCLOSURE OF THE INVENTION

### Technical Problem

An embodiment of the present invention has been devised to solve the above problems, and an object of the prevent invention is to provide a heating apparatus for a vehicle, in which a plate-shaped flow path is formed to reduce cost and time, which are required for producing a product, thereby more improving productivity.

### Technical Solution

A heating apparatus for a vehicle according to an embodiment of the prevent invention includes: a body having an accommodation space with one side surface opened; a heat-generating portion installed on the opened surface of the accommodation space to provide heat; and an inlet/outlet portion connected to the body so that a heat transfer medium is introduced into and discharged from the accommodation space, wherein, as the heat-generating portion is installed, a flow path communicating with the inlet/outlet portion is formed between the body and the heat-generating portion.

The flow path may include a pair of first flow paths communicating with the inlet/outlet portion to allow the heat transfer medium to move in a first direction and a plate-shaped second flow path that connects the pair of first flow paths to each other to allow the heat transfer medium to move in a second direction.

The accommodation space may include a pair of concave portions forming one side surface of each of the first flow paths and a flat portion protruding between the pair of concave portions to form one side surface of the second flow path.

A cross-sectional area of the second flow path in the first direction may have a value corresponding to 100% or more and 300% or less of that of a cross-sectional area of the inlet/outlet portion in the second direction.

The heat-generating portion may further include a reinforcing portion that passes through the second flow path and is coupled to the flat portion.

When an inner diameter of the inlet/outlet portion is 14.5 mm, a height of the second flow path formed between the body and the heat-generating portion may be 0.87 mm or more and 2.6 mm or less.

### Advantageous Effects

As described above, various effects including the following facts may be expected according to the technical problems of the present invention. However, the present invention is unnecessary to allow all of the following effects to be exerted.

In the heating apparatus for the vehicle of the present invention, the method separately forming the flow path through the flat portion forming the second flow path may be excluded to reduce the number of components, thereby reducing the cost required for producing the product and also reducing the fatigue of the worker so as to significantly improve the productivity of the product.

In addition, the reinforcing portion that passes through the second flow path to fix the body and the cover may be additionally provided in addition to the coupling member that fixes the body and the cover to prevent the heat-generating portion from being deformed convexly due to the flow rate and the temperature, thereby improving the durability of the product.

Here, the reinforcing member may pass through the second flow path to generate the turbulence in the heat transfer medium so that the heat is uniformly transferred by the circulation of the heat transfer medium, thereby improving the reliability of the product and also improving the heat transfer efficiency.

In addition, the cross-sectional area of the second flow path in the second direction may have the value corresponding to 100% or more and 300% or less of that of the cross-sectional area of the inlet/outlet portion in the first direction so that the differential pressure below the certain level is maintained between the inflow port and the outflow port to prevent the pump from being damaged and prevent the temperature of the hot spot of the heat-generating portion from rising above the certain temperature, thereby improving the durability of the product.

### BRIEF DESCRIPTION OF THE DRAWINGS

FIG. 1 is a perspective view of a heating apparatus for a vehicle according to an embodiment of the present invention.

FIG. 2 is an exploded perspective view of FIG. 1.

FIG. 3 is a perspective view of FIG. 2 in a different direction.

FIG. 4 is a side view illustrating a state in which a heat-generating portion is removed in FIG. 1.

FIG. 5 is a cross-sectional view taken in a direction V-V of FIG. 1.

FIG. 6 is a cross-sectional view taken in a direction VI-VI of FIG. 1.

FIG. 7 is a table showing experimental data depending on a height of the heating apparatus for the vehicle according to an example of the present invention.

### MODE FOR CARRYING OUT THE INVENTION

Hereinafter, specific embodiments of the present invention will be described in detail with reference to the, accompanying drawings. However, descriptions of well-known functions or configurations are omitted so as not to obscure the gist of the present invention.

In addition, first and second directions used below are directions that intersect each other and are defined based on a direction in which a heat transfer medium flows for convenience of explanation.

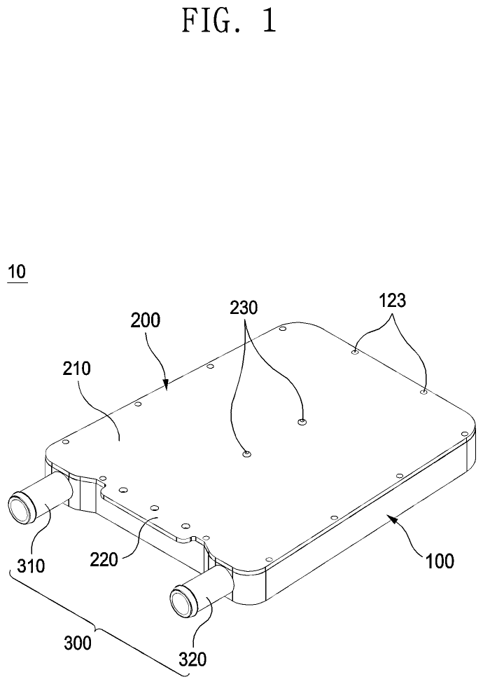

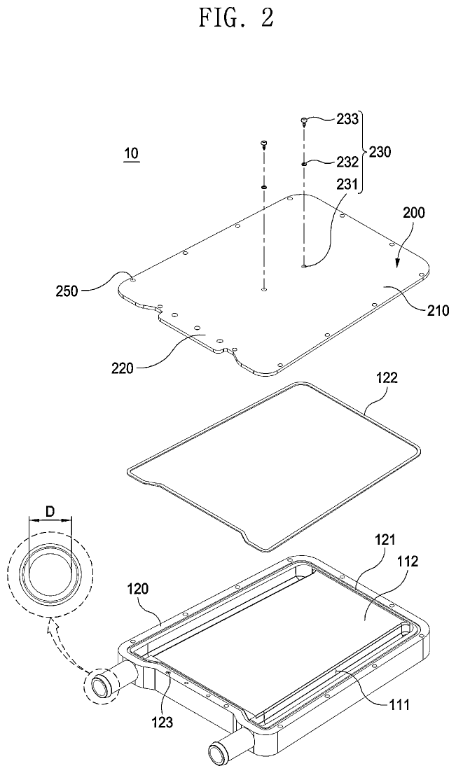

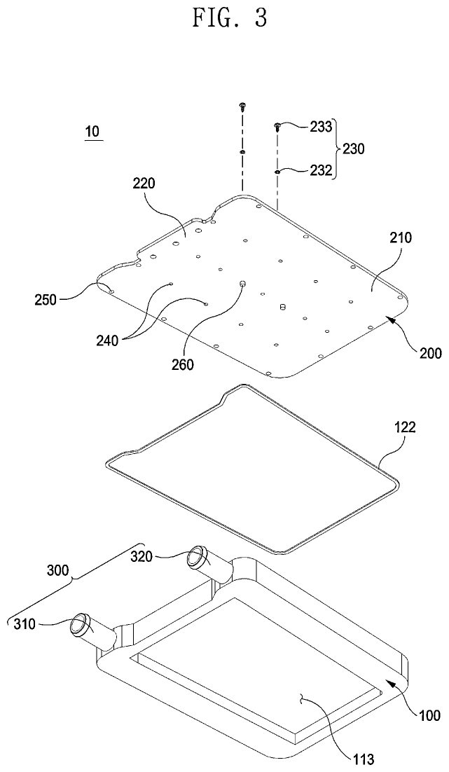

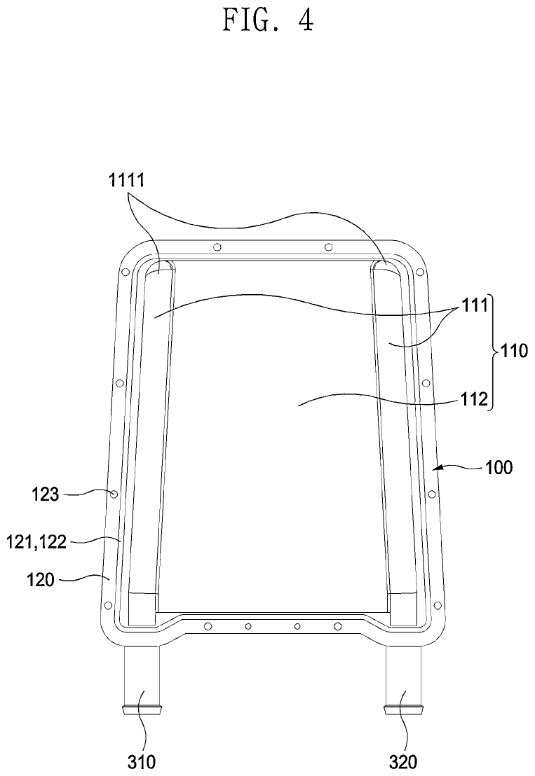

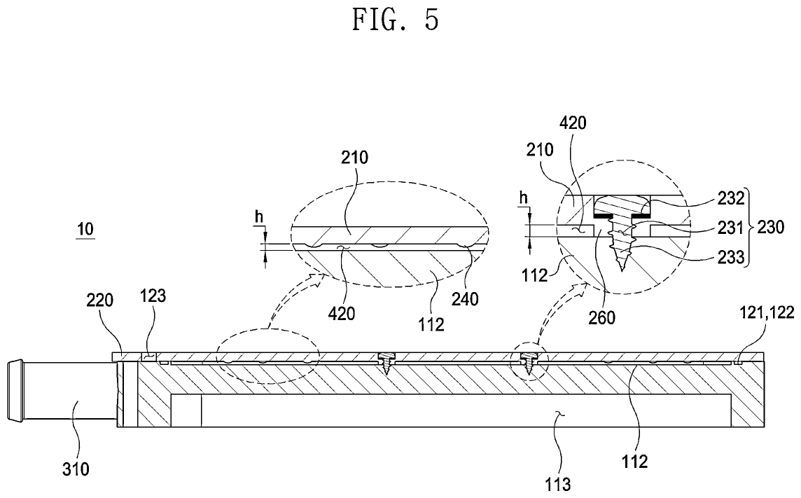

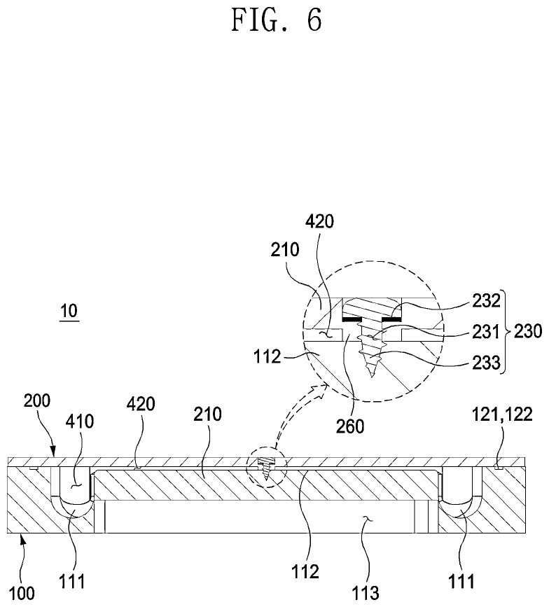

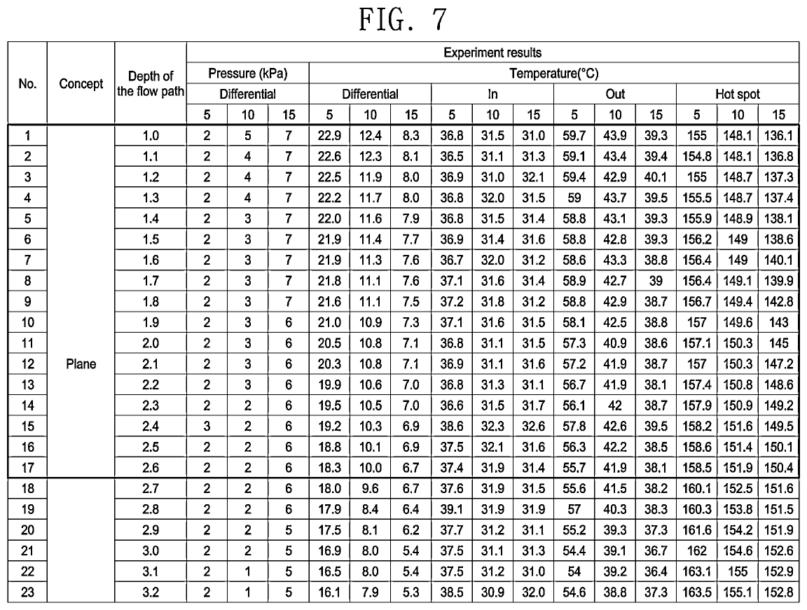

FIG. 1 is a perspective view of a heating apparatus for a vehicle according to an embodiment of the present invention, FIG. 2 is an exploded perspective view of FIG. 1, and FIG. 3 is a perspective view of FIG. 2 in a different direction. FIG. 4 is a side view illustrating a state in which a heat-generating portion is removed in FIG. 1, FIG. 5 is a cross-sectional view taken in a direction V-V of FIG. 1, FIG. 6 is a cross-sectional view taken in a direction VI-VI of FIG. 1, and FIG. 7 is a table showing experimental data depending on a height of the heating apparatus for the vehicle according to an example of the present invention.

Referring to FIGS. 1 to 7, a heating apparatus 10 for a vehicle according to an embodiment of the present invention includes a body 100 having an accommodation space 110 with one side surface opened; a heat-generating portion 200 installed on the opened surface of the accommodation space 110 to provide heat; and an inlet/outlet portion 300 connected to the body 100 so that a heat transfer medium is introduced into and discharged from the accommodation space 110, wherein, as the heat-generating portion 200 is installed, a flow path communicating with the inlet/outlet portion 300 is formed between the body 100 and the heat-generating portion 200.

The body 100 is provided with the accommodation space 110 with the one side surface opened and a seating end 120 on which the heat-generating portion 200 is seated along a circumference of the opened surface of the accommodation space 110 so that the heat transfer medium receives heat so as to be heated while moving along the accommodation space 110.

The accommodation space 110 has the opened one side surface, and a bottom surface formed to be opposite to the opened one side surface is provided with concave portions 111, each of which forms one side surface of a first flow path 410, and a flat portion 112 forming one side surface of a second flow path 420 between the concave portions 111 so that the heat transfer medium is introduced along the inflow port 310 in the first direction. The introduced heat transfer medium moves in the second direction and then is discharged again in the first direction, and thus, the heat is transferred to the entire one side surface without a separate additional flow path structure to realize uniform heat transfer.

The concave portion 111 is formed to have a concave cross-section in the first direction to allow the heat transfer medium to be introduced and discharged smoothly through the outlet/outlet portion connected through one side surface of the body 100 and is formed to be recessed to a certain depth or more inside the body 100 so as to accommodate the entire cross-sectional area of the inflow port 310 and the outflow port 320 in the first direction.

Here, the other end of the concave portion 111, which is not connected to the inflow port 310 or the discharge port 320, is provided with the concave portion 111 and a swirling space 1111 that is formed with a curved surface at a portion that is in contact with one side surface of the body 100 disposed in the first direction so that the heat transfer medium introduced along the first flow path 410 is circulated in the swirling space 1111 to smoothly move to the second flow path 420, and also, the heat is uniformly transferred to the heat transfer medium to improve thermal efficiency.

The flat portion 112 protrudes between the concave portions 111 so that the heat is efficiently transferred to the heat transfer medium while moving along the second flow path 420, and a depth of the second flow path 420 has a predetermined set value in a state in which the heat-generating portion 200 is coupled to the body 100.

Here, the flat portion 112 is formed so that a length of the cross-section in the second direction is constant along the first direction regardless of the shape of the body 100, and a flow rate of the heat transfer medium is easily controlled through a design of the depth of the second flow path 420 according to a degree of recess of the flat portion 112.

In addition, it is desirable to form a void 113 outside the flat portion to realize lightweighting of the heating apparatus 10 for the vehicle.

The seating end 120 is formed to have a certain area along a circumference of the opened surface of the accommodation space 110 so that the heat-generating portion 200 is stably fixed to the body 100. Here, the seating end 120 is provided with a seating groove 121 which is a portion at which the body 100 and the heat-generating portion 200 are in contact with each other and is recessed along the seating end 120 to prevent the heat transfer medium from being lost, a first sealing 122 installed in the seating groove 121, and a first coupling hole 123 which is sequentially passing through the heat-generating portion 200 and the body 100 to provide a certain pressure and to which a coupling member for coupling the heat-generating portion 200 is coupled.

Thus, the heating apparatus 10 for the vehicle according to the present invention is provided with the concave portion 111, through which the heat transfer medium moves in the first direction, in a bottom surface of the accommodation space 110 and the flat portion 112 formed between the concave portions 111 to allow the heat transfer medium to move in the second direction in the state in which the heat transfer medium is in direct contact with one side surface of a heat-generating body, and thus, since there is no need for the separate flow path, the required configuration is minimized to significantly improve workability and product productivity.

The heat-generating portion 200 is disposed to cover the opened surface of the accommodation space 110 and is fixed to the body 100 by the coupling member to provide heat and form the flow path. Specifically, the heat-generating portion 200 is provided with a cover portion 210 disposed at one side of the accommodation space 110, an extension portion 220 on which a terminal extending from one side of the cover portion 210 to provide electricity to the heat-generating portion 200 is installed, a reinforcing portion 230 coupled to the body 100 by passing through the cover portion 210, a protrusion 240 protruding from an inner surface of the cover portion 210, and a second coupling hole corresponding to a position of the first coupling hole 123.

The cover portion 210 is installed on one side surface of the accommodation space 110 to close the opened surface so as to allow the heat transfer medium to be circulated inside the heating apparatus 10 for the vehicle and also is disposed opposite the flat portion 112 so that the second flow path 420 has a pre-designed height.

The extension portion 220 extends from one side of the cover portion 210 and is formed to protrude to the outside of the body 100. Thus, the terminal that provides electricity to the heat-generating portion 200 is installed stably. Here, it is preferable that a hole be formed in the extension portion 220 so that the terminal is easily installed using the coupling member.

The reinforcing portion 230 passes through the cover portion 210 and the second flow path 420 and is coupled to the body 100, that is, the flat portion 112 to prevent the heat-generating portion 200 from being convexly deformed outward by an increase in flow per minute (LPM) of the heat transfer medium, an increase in internal pressure and thermal deformation on the second flow path 420 due to the temperature increase.

Specifically, the reinforcing portion 230 is provided with a reinforcing hole 231 passing through the cover portion 210, a second sealing 232 installed along a circumference of the reinforcing hole 231, and a reinforcing member 233 coupled to the flat portion 112 by passing through the reinforcing hole 231 and the second flow path 420 so as to be formed as the reinforcing hole 231, thereby preventing the cover portion 210 from being deformed due to the increase in temperature and pressure.

Here, the reinforcing member 233 is formed to pass through the second flow path 420 so that, when the heat transfer medium moves to the second flow path 420, turbulence is inevitably generated around the reinforcing member 233 to cause a flow of the heat transfer medium in a direction different from the second direction to ensure a more uniform temperature throughout the heat transfer medium.

Here, in order to more effectively prevent the cover portion 210 from being deformed, it is preferable that the reinforcing portion 230 is formed at a center of the cover portion 210, and if necessary, a plurality of reinforcing portions 230 may be formed to have a pattern.

Additionally, the protrusion 240 may be formed on the bottom surface of the cover portion 210 to generate additional turbulence in the heat transfer medium moving on the second flow path 420 and also serve as a heat dissipation fin. Here, the number and arrangement of protrusions 240 may vary according to a design in which the protrusion 240 protrudes onto the second flow path 420, and the reinforcing portion 230 passes onto the second flow path 420 to generate the turbulence.

Here, the protrusion 240 is formed not only on the bottom surface of the cover portion 210 but also on the flat surface 112 that forms the second flow path 420 to face the cover portion 210 in order to generate the turbulence and heat dissipation throughout the heat transfer medium.

The second coupling groove 250 is formed to correspond to the position of the first coupling hole 123 formed on the seating end 120 to firmly couple the body 100 and the heat-generating portion 200 and also apply a pressure the first sealing 122 at a certain interval, thereby preventing the heat transfer medium from being lost.

However, the heat-generating portion 200 is not coupled to the body 100 only by the coupling members such as bolts, etc., and may also be coupled to the body 100 by other methods such as welding, which is obvious at the level of a person skilled in the art.

A protective rib 260 communicates with the reinforcing hole 231 and is formed to protrude from the bottom surface of the cover portion 210 to prevent the reinforcing member 233 and the heat transfer medium from being in direct contact with each other when the reinforcing member 233 passes through the second flow path 420, thereby preventing the reinforcing member 233 from corroding and preventing the heat transfer medium from being lost through the reinforcing portion 230.

Here, an example of the protective rib 260 is formed on the bottom surface of the cover portion 210, but depending on the design, the protective rib 260 may be formed to protrude from the flat surface 112 corresponding to the position of the reinforcing hole 231.

The inlet/outlet portion 300 is provided with the inflow port 310 formed to pass through the body 100 so as to allow the heat transfer medium to be introduced in the first direction and the discharge port 320 formed to pass through the body 100 so that the heat transfer medium moves along the second flow path 420 and then is discharged again in the first direction.

The flow path 400 is formed between the heat-generating portion 200 and the concave portion 111 and is provided with a pair of first flow paths 410 connected to the inflow port 310 or the discharge port 320 at one side and a second flow path 420 formed between the heat-generating portion 200 and the flat portion 112 to allow the pair of first flow paths 410 to communicate with each other. Here, the void 113 is formed outside the flat portion 112, and thus, the flat portion 112 protrudes to the inside of the accommodation space 110 to limit a height h of the second flow path 420.

Thus, the heat transfer medium may be efficiently heated by securing a contact area relative to the flow rate between the heat-generating portion 200 and the heat transfer medium at a certain level without a separate flow path member.

Specifically, describing the movement of the heat transfer medium, the heat transfer medium moves in the first direction through the first flow path 410 formed in the first direction in one side surface of the body 100 through the inflow port 310, and when the heat transfer medium is fully filled into the first flow path 410, the heat transfer medium is introduced into the second flow path 420 to move in the second direction, and then, the heat transfer medium moves to another first flow path 410 formed in the first direction at the other side of the body 100, and accordingly, the heat transfer medium is discharged again in the first direction along the discharge port 320.

Thus, the heat transfer medium is in contact with the bottom surface of the cover part 210 while moving along the second flow path 420 to receive heat so as to be heated. Here, the height of the second flow path 420 is limited so that the heat is transferred uniformly throughout the heat transfer medium.

According to tests, it is preferable that the cross-sectional area of the second flow path 420 in the first direction is 100% or more to 300% or less of the cross-sectional area in the second direction of the inflow port 310 (or discharge port 320), and this means that a flow rate per minute, at which the heat transfer medium introduced into the inflow port 310, is more than ⅓ and has the same maximum flow rate so that the heat is efficiently transferred from the heat-generating portion 200 to the heat transfer medium.

Thus, the heating apparatus 10 for the vehicle according to the present invention realizes miniaturization and lightweighting by excluding the separate flow path member that formed as the conventional flow path so as to secure a contact area between the heat transfer medium and the heat-generating portion 200.

In addition, a production work process is simplified to reduce production time and costs and improves workability of a worker to significantly improve product productivity.

In one example of the heating apparatus 10 for the vehicle, an inner diameter of the inflow port 310 is formed to be 14.5 mm, a width of the second flow path 420 in the second direction is formed to be 190 mm, and thus, it is preferable that a height of the second flow path 420 is 0.87 mm or more and 2.6 mm or less.

Here, when considering that the flow rate of the heat transfer medium introduced into the heating apparatus 10 for the vehicle is generally 5 LPM to 15 LPM, in consideration of a pressure difference between the inflow port 310 and the discharge port 320 and a temperature of the hot spot at which a temperature of a portion of the heat-generating portion 200 increases rapidly, it is preferable that the height of the second flow path 420 is 1 mm or more and 2.6 mm or less.

In the case in which the height of the second flow path 420 of the heating apparatus 10 for the vehicle is 1 mm or more and 2.6 mm or less, the pressure difference between the inflow port 310 and the discharge port 320 is maintained from 2 Kpa to 7 Kpa as shown in the table shown in FIG. 7 to prevent the pump that calculates the heat transfer medium from being overloaded and also maintain the temperature of the hot spot at 160° C. or less, thereby securing the durability of the product.

In summary, the heating apparatus 10 for the vehicle according to the present invention limits the dimensions of the inlet/outlet portion 300 and the second flow path 420 to efficiently transfer the heat to the heat transfer medium without the separate flow path member and also significantly improve the durability and productivity of the product.

Although the exemplary embodiment of the present invention is illustratively described, the technical scope of the present invention is not limited to only the specific embodiment, and thus all suitable modifications and equivalents coming with the scope of the appended claims.

What is claimed is:

1. A heating apparatus for a vehicle, comprising:
a body having an accommodation space with one side surface opened;
a heat-generating portion installed on the opened surface of the accommodation space to provide heat; and
an inlet/outlet portion connected to the body so that a heat transfer medium is introduced into and discharged from the accommodation space,
wherein, as the heat-generating portion is installed, a flow path communicating with the inlet/outlet portion is formed between the body and the heat-generating portion.

2. The heating apparatus for the vehicle of claim 1, wherein the flow path comprises:
a pair of first flow paths communicating with the inlet/outlet portion to allow the heat transfer medium to move in a first direction; and
a plate-shaped second flow path that connects the pair of first flow paths to each other to allow the heat transfer medium to move in a second direction.

3. The heating apparatus for the vehicle of claim 2, wherein the accommodation space comprises:
a pair of concave portions forming one side surface of each of the first flow paths; and
a flat portion protruding between the pair of concave portions to form one side surface of the second flow path.

4. The heating apparatus for the vehicle of claim 3, wherein a cross-sectional area of the second flow path in the first direction has a value corresponding to 100% or more and 300% or less of that of a cross-sectional area of the inlet/outlet portion in the second direction.

5. The heating apparatus for the vehicle of claim 3, wherein the heat-generating portion further comprises a reinforcing portion that passes through the second flow path and is coupled to the flat portion.

6. The heating apparatus for the vehicle of claim 4, wherein, when an inner diameter of the inlet/outlet portion is 14.5 mm, a height of the second flow path formed between the body and the heat-generating portion is 0.87 mm or more and 2.6 mm or less.
